(19) United States
(12) Patent Application Publication
(10) Pub. No.: US 2021/0062779 A1
(43) Pub. Date: Mar. 4, 2021

(54) ROCKING LEVER ASSEMBLY FOR HARNESSING ENERGY FROM SURFACE WAVES

(71) Applicant: Ahmad Hussain, Bengaluru (IN)

(72) Inventor: Ahmad Hussain, Bengaluru (IN)

(21) Appl. No.: 16/964,991

(22) PCT Filed: Jan. 12, 2019
(86) PCT No.: PCT/IN2019/050031

§ 371 Date: Jul. 26, 2020

(30) Foreign Application Priority Data
Jan. 23, 2018 (IN) 201831002688

(51) Int. Cl. F03B 13/18

(52) U.S. Cl. CPC F03B 13/1815; F05B 2240/50; F05B 2240/40

(57) ABSTRACT

Disclosed is rocking lever assembly for harnessing energy from surface waves. A rocking lever (303), connecting a floating body (301) and a dense solid body (302) with the flexible links (306/307) at the opposite arms (304/305) and a freewheeling mechanism (308/309) in between, rocks to rotate a line shaft (310/311) with the descending waves underneath floating body (301), in bearings mounted on a frame (320) held above waves. Sets of similar rocking levers (303), installed side by side, rotate said line shaft (310) uniformly. Another parallel line shaft (311), with similar accessories, mounted on the same frame to rotate oppositely, counters the overturning of said frame (320). These line shafts rotate one common shaft (315) unidirectional which being used as prime mover.

### TECHNICAL FIELD

This invention relates to a device for harnessing energy from surface waves by mechanical means.

### BACKGROUND ART

One of the early devices here-to-fore known to harness energy from surface waves uses long float 101 (FIG. 1). The said long float 101 (FIG. 1) is attached with a freewheeling mechanism 103 (FIG. 1) at its one end to rotate a shaft 102 (FIG. 1) in one direction only while the other end of the said long float is left free to rock with the waves underneath in vertical plane. The said long float 101 (FIG. 1) crosses over several waves (as illustrated in FIG. 1 by the schematic view of crest and trough of waves underneath said long float). This results in the said long float 101 (FIG. 1) being pushed upward by the thrust of ascending waves with force F₁, F₂, . . . (indicated by arrows in upward direction) and pulled downward by the pull of descending waves with forces V₁, V₂, V₃, . . . (indicated by arrows in downward direction). The net resultant force acting on said long float equals to F (were F=F₁+F₂+F₃+ . . . −V₁−V₂−V₃− . . . ) in upward direction. This situation reduces the net resultant force ‘F’ to very low value, thereby reducing net energy harnessed by this device to the insignificantly minimum. Besides this said long float itself hinders to the propagation of waves.

Another device here-to-fore known to harness energy from the surface waves uses a small float floating on the surface of waves and connected with the help of kinematic linkage to transmit energy of waves underneath to the rotor of a small capacity generator installed on a raised platform. This device suffers with the problem of heavy loss of energy in friction due to rubbing of mating parts of said kinematic linkage. As the said kinematic linkage falls hard on the waves pushing or pulling said float from underneath, the amplitude of rocking of said float gets reduced appreciably. This reduces the amount of energy transmitted to said generator. The clumsy kinematic linkage affects adversely the economy in the cost of manufacture, installation and maintenance.

Still another device here-to-fore known to harness energy from surface waves uses buoys rocking over waves. The energy of waves is firstly imparted to the buoys of larger volume, as compared to the above said small float, in order to accommodate inside a flywheel, a gears train and a fractional power generator. A large portion of wave energy, imparted to rocking buoys, is wasted in rocking the bulky buoys. A very little amount of energy gets transmitted to the rotor of said generator installed inside. Moreover, it is not feasible to couple mechanically a number of buoys for operating one single generator of large capacity.

### SUMMARY OF INVENTION

### Technical Problem

The devices for harnessing energy from surface waves, here-to-fore known, are of insignificantly small capacities and may not be coupled together to run a large capacity generator. This is because these devices are not feasible to generate power on large scale.

### Solution to Problem

To mitigate the afore-said drawbacks as experienced with the here-to-fore known devices, in the present invention, there is provided rocking lever assembly for harnessing energy from surface waves comprising at least a floating body, a dense solid body, a rocking lever with two arms in opposite directions and a freewheeling mechanism in between, a plurality of flexible links, at least a line shaft, a plurality of bearing housings with bearings, a frame, a common shaft, at least a flywheel, a plurality of power transmitting means (e. g. a plurality of belt and pulleys or/and gears trains).

The said floating body of suitable shape and weight is attached with one end of a flexible link of suitable length, the other end of which is attached with the end of one arm of said rocking lever. The end of the opposite arm of said rocking lever is attached with another flexible link, the other end of which is attached with said dense solid body of suitable weight and shape.

The said rocking lever, with two said arms on the opposite sides and a freewheeling mechanism in between, is mounted on said line shaft. The said line shaft is rotatable in bearings. The said bearings are mounted on said line shaft and housed in said bearing housings. The said bearing housings are mounted on the opposite sides of, preferably a substantially rectangular frame. The said frame along with said line shaft and said rocking lever is held above the surface of waves and stationed at a preferred location (the most suitable for the availability of waves with maximum amplitude) on being attached, preferably detachably with suitably shaped anchored floats or with suitable structural supports (designed to pose the least possible interference to the propagation of waves). The said rocking lever along with said arms on the opposite sides and said freewheeling mechanism in between is rock able with angular motion in a substantially vertical plane on said line shaft about its axis as fulcrum.

The said floating body is pushed upward by the force of ascending wave from underneath. This causes a decrease of tension in said flexible link attaching said floating body. The decrease of tension in said flexible link (attaching said floating body) causes said dense solid body (attached with the end of the opposite arm of said rocking lever) to fall down by pulling said arm of said rocking lever (to which it is attached) along by rotating freely with said freewheeling mechanism on said line shaft (as the free rotation is allowed here in clockwise direction on said line shaft). This causes said arm of said rocking lever (on the side of said floating body) to move upward by stretching said flexible link (attached with said floating body) with a consequent regain of tension in said flexible link. The weight of said dense solid body (including that of said flexible link on this side) and the length of the arm of said rocking lever (on this side) are chosen to produce a moment just sufficient to maintain said flexible link (attaching said floating body) free of any sag or backlash up to the period till so long as the wave underneath said floating body keeps on rising to attain crest. After attaining crest the wave underneath said floating body starts receding down. This causes said floating body to fall down by pulling said arm of said rocking lever down in anti-clockwise direction along with said freewheeling mechanism by rotating said line shaft in anti-clockwise direction (as the free rotation of said freewheeling mechanism on said line shaft is not allowed in anti-clockwise direction) with a net torque T (the amount of net torque exerted on said line shaft by falling down floating body in anticlockwise direction after subtracting the value of torque exerted by said dense solid body acting on the arm of said rocking lever in clockwise direction). The above said situation prevails up to the period till the wave underneath said floating body keeps on sinking down towards the depth (i.e. the trough). The wave underneath said floating body keeps on repeating the above said cycle along with said floating body and so on the cycle of rocking of said rocking lever too goes on repeating.

FIG. 2 illustrate in schematic view the principle of working of a single rocking lever 203 with arm 204 (of length L) and 205 (of length l) in opposite directions, a floating body 201 (of weight W), a dense solid body 202 (of weight w) and flexible links 206 and 207 connecting floating body 201 and dense solid body 202, respectively with the opposite arms of rocking lever 203. The bold and dotted lines indicate two extreme positions of rocking lever 203, floating body 201, dense solid body 202 and trough and crest of wave underneath.

The rocking lever 203 rocks in between extreme positions (shown by bold and dotted lines) with the push of wave underneath (extreme positions shown by bold and dotted lines) over a freewheeling mechanism 208 operative in a direction to rotate a line shaft 210 in anticlockwise direction only. The downward pull exerted by said floating body 201 (FIG. 2) of weight W (along with the weight of said flexible link) through an effective length L (the distance from the axis of rotation of said line shaft 210 (FIG. 2) to the point of attachment of said flexible link 206 (FIG. 2) attaching said floating body 201 with said arm 204 of said rocking lever 203 (as illustrated in FIG. 2) exerts an anti-clockwise torque of magnitude W×L and simultaneously said dense solid body of weight w (along with said flexible link 207) through an effective arm length l (the distance from the axis of rotation of said line shaft to the point of attachment of said flexible link attaching said dense solid body 202 with said arm 205 of said rocking lever as illustrated in FIG. 2) exerts a torque of magnitude w×l in clockwise direction on said rocking lever 203. The net torque T in anti-clockwise direction about the axis of said line shaft 210 thus equals to WL−wl.

In order to maximize this resultant torque T the product W×L is made as large as feasible and w×l as small as possible. This is achieved by selecting the weight W and w and length L and l suitably. The weight W of said floating body is kept as heavy (for exerting the maximum force while falling down) and volume as large as possible (for keeping on floating but with the least possible contact with the surface of wave). The weight w is made as small as possible, to maintain just sufficient amount of tension in said flexible link on the side of said floating body for making it just free of any sag or back lash throughout the rocking cycle.

The said net torque T on said line shaft is available during half of the rocking cycle only (i.e. during the period till the wave underneath said floating body continues to recede down). In order to maintain this torque available uniformly throughout the rocking cycles for keeping said line shaft on revolving continuously in anticlockwise direction a plurality of said rocking levers with said freewheeling mechanisms (with free rotation in clockwise direction) along with said accessories (e.g. said floating body, said dense solid body, said flexible links) attached with the corresponding arms of said rocking levers with varying arm lengths L and l (in order to cover a number of waves simultaneously) and corresponding suitable weights W of said floating body and w of said dense solid body are chosen such that the average value of the net torque T exerted by all the rocking levers on said line shaft being substantially uniform throughout. The said rocking levers are arranged side by side and as close to each other as practically feasible (in order to accommodate an increased number of said rocking levers in per unit area of the surface waves for increased power output) but maintaining a minimum distance in between for avoiding intermingling of said flexible links with each other. The said arrangement keeps said line shaft on revolving continuously in anti-clockwise direction with fairly uniform speed. In order to restrict the fluctuation in the speed of rotation of said line shaft within permissible limits a single or a plurality of flywheels of appropriate moment of inertia is mounted on said line shaft.

The rotation of said line shaft in only one direction (here in anticlockwise direction) produces an unbalanced moment trying to overturn said frame. In order to counterbalance this moment another line shaft, in parallel with the said line shaft along with said rocking lever and above said accessories with freewheeling mechanism operative in a direction to rotate this line shaft in clockwise direction (i.e. in a direction opposite to that of previously said line shaft), is provided. The said line shaft is rotatable on said bearings housed in said bearing housings, said bearing housings being mounted on the opposite sides of said frame. The said arms of said rocking levers attaching said floating body and said dense solid body is arranged here in a fashion (i.e. said floating body now is on the side of said line shaft in a position opposite to that of the previously said line shaft) such that the falling down floating body with the descending wave underneath now pulls the arm of said rocking lever to rotate this another line shaft in clockwise direction with the speed of rotation substantially equal to that of previously said line shaft. The rotations of these two parallel line shafts on one frame in opposite directions counter the unbalanced moment produced by each on said frame.

In order to transfer power from the said line shafts rotating in opposite directions into the unidirectional rotation of one common shaft suitable power transmitting means (e.g. belt and pulleys or gears trains or both) are used to rotate one common shaft rotatable in bearings housed in bearing housings mounted on said frame or on the extension of said frame, preferably with the help of brackets.

The said common shaft, with the above said arrangements, rotates in one direction (here in anticlockwise direction) with the force of wave in vertical direction. A single or a plurality of output flywheels is mounted on said common shaft to restrict the fluctuations in the speed of rotation within permissible limits. An extension of said common shaft with suitable power transmitting means (e.g. belt and pulleys or gears trains or both) is used as prime mover for power generator(s) or for rotating other machine(s).

According to a preferred feature of the present invention the said floating body is made of a hollow, preferably cylindrical body with, preferably substantially hemispherical bottom and conical top. The diameter of the cylindrical portion is, preferably less than one fourth of the average wavelength of surface waves prevailing at that location (in order to float with the least possible contact on the surface of waves). The apex of said conical top is attached with said flexible link. The cylindrical portion is, preferably just long enough to the extent that its top conical portion remains always above the splash of water from the surface waves. The said floating body is made heavy enough to exert the maximum possible pulling force on said arm of said rocking lever while falling down with the descending waves underneath, which is achieved, preferably by adding small balls of heavy material inside the hollow floating body made of plastic or of other corrosion resistant materials.

According to another preferred feature of the present invention the said dense solid body is a dense solid mass of thin cylindrical body with conical shape at both ends, one end of which being attached with said flexible link (on the side opposite to that of said floating body). The conical ends allow it to move through water with minimum resistance.

### Advantageous Effect of invention

The main advantage of this device lies in its feasibility to be adopted for harnessing energy commercially on large scale from the vast area of surface waves with the use of large capacity generators. Furthermore, the simplicity and economy in construction, operation and maintenance are its added advantages. It may prove to be a future promising alternative source of energy commercially unexplored so far.

### BRIEF DESCRIPTION OF DRAWINGS

This invention will now be described by the way of example with reference to the accompanying drawings.

FIG. 3 gives in oblique view the arrangement of ‘rocking lever assembly for harnessing energy from surface waves’ with the following details:

301: floating body,

302: dense solid body,

303: rocking lever,

304: arm of rocking lever 303 extending towards floating body 301 side,

305: arm of rocking lever 303 extending towards dense solid body 302 side,

306: flexible link attaching said floating body 301 and arm 304 of rocking lever 303,

307: flexible link attaching said dense solid body 302 and arm 305 of rocking lever 303,

308: freewheeling mechanism operative to drive line shaft 310 in anticlockwise direction,

309: freewheeling mechanism operative to drive line shaft 311 in clockwise direction,

310: line shaft drivable by freewheeling mechanism 308,

311: line shaft drivable by freewheeling mechanism 309,

312: bearing housing with bearing for line shaft 310,

313: bearing housing with bearing for line shaft 311,

314: flywheel on line shaft 310/311,

315: common shaft,

316: pulley on line shaft 310/311 for transmitting power to common shaft 315,

317: pulley on common shaft 315 for receiving power from line shaft 310/311,

318: bearing housing with bearing for housing common shaft 315,

319: bracket for installing bearing housing 318,

320: frame,

321: direct belt for transmitting power from line shaft 310 to common shaft 315,

322: crossed belt for transmitting power from line shaft 311 to common shaft 315,

323: power output flywheel.

324: projection at the corners of frame 320 for being attached detachably with stationary supports (suitably shaped anchored floats or structural supports—not shown).

FIG. 4 (sheet no. 3) gives, in schematic view, the details of a preferred floating body 301 along with a portion of wave underneath:

425: small balls of heavy materials.

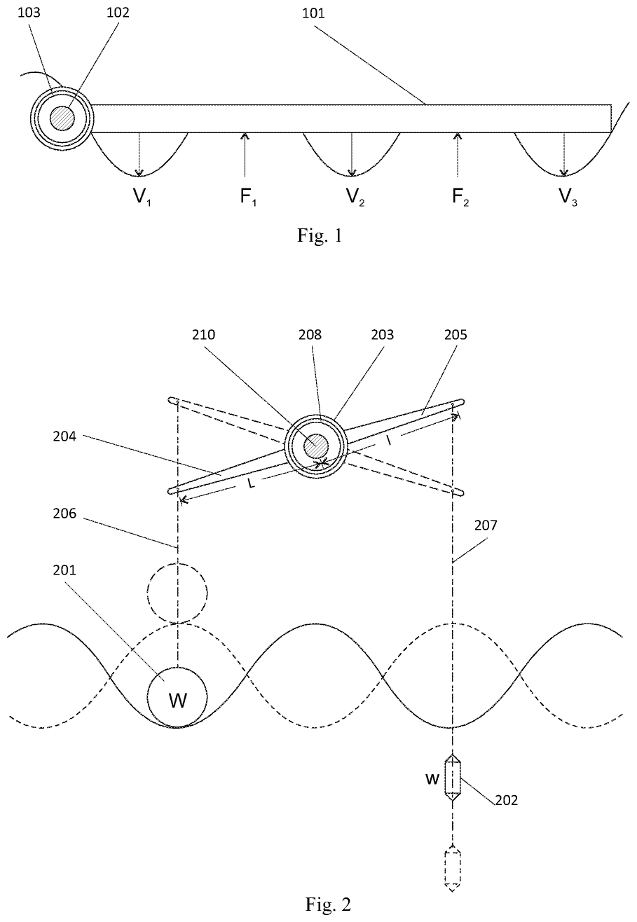

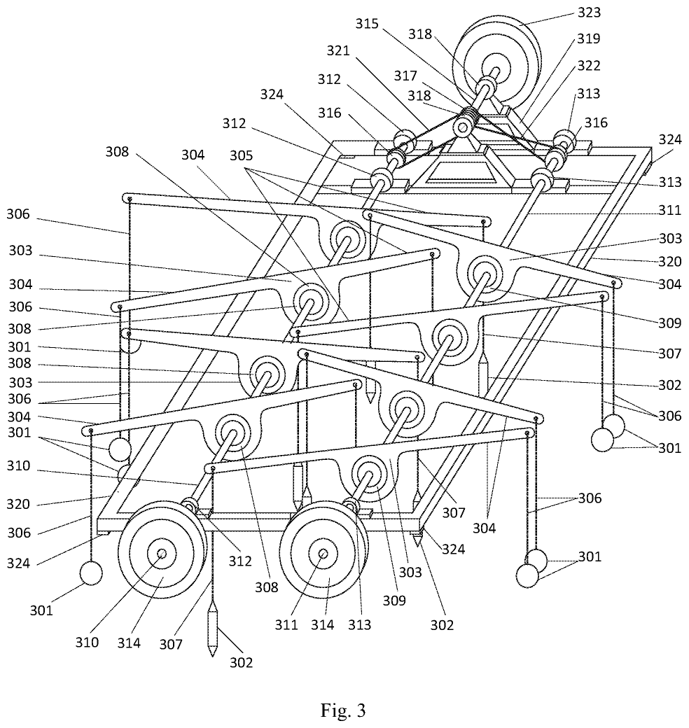

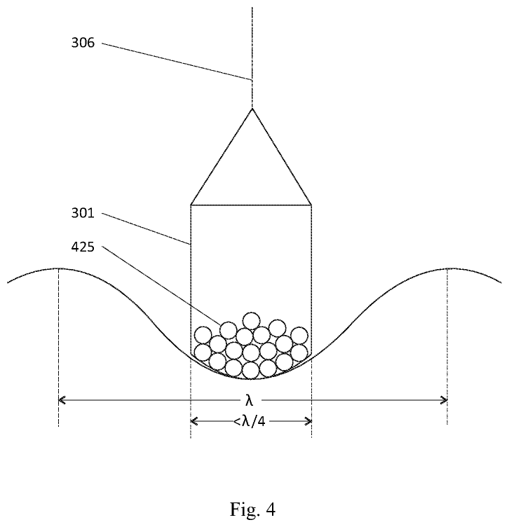

With reference to above said details shown in FIG. 3 and FIG. 4, in the present invention ‘rocking lever assembly for harnessing energy from surface waves’ comprises a floating body 301, a dense solid body 302, a rocking lever 303 with two arms 304 and 305 in opposite directions and a freewheeling mechanism 308/309 in between, flexible link 306 and 307, line shafts 310 and 311, bearing housing (with bearing) 312, 313 and 318, frame 320, pulleys 316 and 317, common shaft 315, brackets 319, flywheels 314 and 323, power transmitting belts 321 and 322.

The floating body 301 is attached with one end of flexible link 306, the other end of which is attached with the end of arm 304 of rocking lever 303. The end of the opposite arm 305 of rocking lever 303, is attached with another flexible link 307, the other end of which is attached with a dense solid body 302. The rocking lever 303, with its two arms 304 and 305 on the opposite sides and a freewheeling mechanism 308 in between, is mounted on line shaft 310. The line shaft 310 is rotatable in bearings mounted on it and housed in bearings housings 312. The bearing housings 312 are mounted on the opposite sides of a rectangular frame 320. The frame 320 along with line shaft 310 and rocking lever 303 is held above the surface of waves and stationed at a preferred location on being attached detachably with the projection 324 of frame 320 with the anchored floats/structures (not shown here).

The rocking lever 303 along with arms 304 and 305 on the opposite sides and freewheeling mechanism 308 in between is rockable with angular motion in a substantially vertical plane on the line shaft 310 about its axis as fulcrum.

The floating body 301 is pushed upward by the force of ascending waves from underneath. This causes a decrease of tension in the flexible link 306 (attaching floating body 301). The decrease of tension in the flexible link 306 causes dense body 302 (attached with the opposite arm 305 of rocking lever 303) to fall down by pulling arm 305 of rocking lever 303 along by rotating freely with freewheeling mechanism 308 on said line shaft 310 (as free rotation is allowed here in clockwise direction on line shaft 310). This causes arm 304 of the rocking lever 303 (on the side of floating body 301) to move upward by stretching flexible link 306 with a consequent regain of tension in it.

The weight of dense solid body 302 (including that of flexible link 306) and the length of the arm 305 of rocking lever 303 on the side of dense solid body 302 are chosen to produce a moment just sufficient to maintain the flexible link 306 (attaching floating body 301) free of any sag or back lash up to the period till so long as the wave underneath floating body 301 keeps on rising to attain crest. After attaining crest, the wave underneath floating body 301 starts receding down. This causes floating body 301 to fall down by pulling arm 304 of rocking lever 303 down in anticlockwise direction along with the freewheeling mechanism 308 by rotating line shaft 310 in anticlockwise direction (as the free rotation of freewheeling mechanism 308 on the line shaft 310 is not allowed in anticlockwise direction) with a net torque T (the amount of net of torque exerted on line shaft 310 by falling down floating body 301 in anticlockwise direction after subtracting the value of torque exerted by dense solid body 302 acting on the arm 305 of rocking lever 303 in clockwise direction). The above said situation prevails up-to the period till the wave underneath floating body 301 keeps on sinking down towards the depth (i.e. the trough). The wave underneath floating body 301 keeps on repeating the above said cycle along with the floating body 301 and so on the cycle of rocking of the rocking lever 303 too goes on repeating.

The said net torque T on line shaft 310 is available during half of the rocking cycle only (i.e. during the period till the wave underneath floating body 301 continues to recede down). In order to maintain this torque available uniformly throughout the rocking cycles for keeping the line shaft 310 on revolving continuously in anticlockwise direction a plurality of (four numbers shown in FIG. 3) rocking levers 303 with the freewheeling mechanisms 308 (with free rotation in clockwise direction) along with the accessories (e.g. floating body 301, dense solid body 302, flexible links 306 and 307) attached with the arms 304 and 305 of the rocking lever 303 with varying arm lengths L and l (FIG. 2) (in order to cover a number of waves simultaneously) and corresponding suitable weights W and w (FIG. 2) of floating body and dense solid body respectively are chosen such that the average value of net torque T exerted by all the rocking levers 303 on the line shaft 310 being substantially uniform throughout. The rocking levers 303 are arranged side by side and as close to each other as practically feasible (in order to accommodate an increased number of rocking levers 303 in per unit area of the surface waves for increased power output) but maintaining a minimum distance in between for avoiding intermingling of flexible links 306 and 307 with each other. This arrangement keeps the line shaft 310 on revolving continuously in anticlockwise direction with fairly uniform speed. In order to restrict the fluctuation in the speed of rotation of the line shaft 310 within permissible limits a flywheel 314 of appropriate moment of inertia is mounted on the line shaft 310.

The rotation of line shaft 310 in only one direction (here in anticlockwise direction) produces an unbalanced moment trying to overturn the frame 320. In order to counterbalance this moment another line shaft 311, in parallel with the line shaft 310 along with the rocking lever 303 and above said accessories with the freewheeling mechanism 309 operative in a direction to rotate the line shaft 311 in clockwise direction (i.e. in a direction opposite to that of the line shaft 310), is provided. The line shaft 311 is rotatable on bearings housed in the bearing housings 313. The said bearing housings 313 are mounted on the opposite sides of frame 320. The arms 304 and 305 of the rocking levers 303 attaching the floating body 301 and the dense solid body 302 is arranged here in a fashion (i.e. floating body 301 now is on the side of line shaft 311 in a position opposite to that of the line shaft 310) such that the falling down floating body 310 with the descending wave underneath now pulls the arm 304 of rocking lever 303 to rotate this line shaft 311 in clockwise direction with the speed of rotation substantially equal to that of the line shaft 310. The rotations of these two parallel line shafts 310 and 311 on one frame 320 in opposite directions counters the unbalanced moments produced by each on the frame 320.

In order to transfer power from the line shafts 310 and 311 rotating in opposite directions into the unidirectional rotation of one common shaft 315 pulleys 316 are mounted on line shafts 310 and 311 for transmitting power to pulleys 317, mounted on the common shaft 315, with the help of direct belting 321 for transmitting power in the same anticlockwise direction from line shaft 310 and by crossed belting 322 for transmitting power from the line shaft 311, rotating in clockwise direction, after converting into anti-clockwise direction. The common shaft 315 is rotatable on bearings housed in the bearing housing 318. The bearing housing 318 is mounted on the frame 320 with the help of brackets 319.

The common shaft 315, with above said arrangements, rotates in anticlockwise direction with the force of wave in vertical direction. An output flywheel 323 is mounted on common shaft 315 to restrict the fluctuations in speed of rotation within permissible limits.

An extension (not shown here in the figure) of common shaft 315 with suitable power transmitting means (e.g. belts or gear trains or both—not shown in Fig.) is used as prime mover for power generator(s) or for rotating other machine(s) (not shown).

According to a preferred feature of present invention the floating body 301 (FIG. 4) is made of a hollow cylindrical body with substantially hemispherical bottom and conical top. The diameter of the cylindrical portion being, preferably less than one fourth of the average wave length of surface waves prevailing at that location (in order to float with least possible contact on the surface of waves). The apex of said conical top is attached with flexible link 306 (FIG. 4). The cylindrical portion is just long enough to the extent that its top conical portion remains always above the splash of water from the surface waves. The floating body 301 is made heavy enough to exert the maximum possible pulling force on arm 304 of rocking lever 303 while falling down with the descending waves underneath. This is achieved by adding small balls 425 (FIG. 4) of heavy material inside the hollow floating body 301 made of plastic or of other corrosion resistant materials.

According to another feature of the present invention the dense solid body 302 (FIG. 3) is a dense solid mass of thin cylindrical body with conical shape at both ends, one end of which is attached with flexible link 307. The conical ends allow it to move through water with minimum resistance. Thus, in the present invention, there is provided rocking lever assembly for harnessing energy from surface waves comprising at least a floating body, a dense solid body, a rocking lever with two arms in opposite directions and a freewheeling mechanism in between, a plurality of flexible links, at least a line shaft, a plurality of bearing housings with bearings, a frame, a common shaft, at least a flywheel, a plurality of power transmitting means (e.g. a plurality of belt and pulleys or/and gears trains), said floating body of suitable shape and weight being attached with one end of a flexible link of suitable length, the other end of which being attached with the end of one arm of said rocking lever, the end of the opposite arm of said rocking lever being attached with another flexible link, the other end of which being attached with said dense solid body of suitable weight and shape, said rocking lever, with two said arms on the opposite sides and a freewheeling mechanism in between, being mounted on said line shaft, said line shaft being rotatable in bearings, said bearings being mounted on said line shaft and housed in said bearing housings, said bearing housings being mounted on the opposite sides of, preferably a substantially rectangular frame, said frame along with said line shaft and said rocking lever being held above the surface of waves and stationed at a preferred location (the most suitable for the availability of waves with maximum amplitude) on being attached, preferably detachably with suitably shaped anchored floats or with suitable structural supports (designed to pose the least possible interference to the propagation of waves), said rocking lever along with said arms on the opposite sides and said freewheeling mechanism in between being rock able with angular motion in a substantially vertical plane on said line shaft about its axis as fulcrum, said floating body being pushed upward by the force of ascending wave from underneath causing a decrease of tension in said flexible link attaching said floating body, the decrease of tension in said flexible link (attaching said floating body) causing said dense solid body (attached with the end of opposite arm of said rocking lever) to fall down by pulling said arm of said rocking lever (to which it being attached) along by rotating freely with said freewheeling mechanism on said line shaft (as the free rotation being allowed here in clockwise direction on said line shaft) causing said arm of said rocking lever (on the side of said floating body) to move upward by stretching said flexible link (attached with said floating body) with a consequent regain of tension in said flexible link, the weight of said dense solid body (including that of said flexible link on this side) and the length of the arm of said rocking lever (on this side) being chosen to produce a moment just sufficient to maintain said flexible link (attaching said floating body) free of any sag or backlash up to the period till so long as the wave underneath said floating body keeping on rising to attain crest, after attaining crest the wave underneath said floating body starting to recede down causing said floating body to fall down by pulling said arm of said rocking lever down in anti-clockwise direction along with said freewheeling mechanism by rotating said line shaft along in anti-clockwise direction (as the free rotation of said freewheeling mechanism on said line shaft being not allowed in anticlockwise direction) with a net torque (the net amount of torque exerted on said line shaft by falling down floating body in anticlockwise direction after subtracting the value of torque exerted by said dense solid body acting on the arm of said rocking lever in clockwise direction), the above said situation prevailing up to the period till the wave underneath said floating body keeping on sinking down towards the depth (the trough), the wave underneath said floating body keeping on repeating the above said cycle along with said floating body and so on the cycle of rocking of said rocking lever too going on repeating, said net torque on said line shaft being available during half of the rocking cycle only (during the period till the wave underneath said floating body continuing to recede down), in order to maintain this torque available uniformly throughout the rocking cycles for keeping said line shaft on revolving continuously in anticlockwise direction a plurality of said rocking levers with said freewheeling mechanisms (with free rotation in clockwise direction) along with said accessories (e.g. said floating body, said dense solid body, said flexible links) attached with the corresponding arms of said rocking levers with varying arm lengths (in order to cover a number of waves simultaneously) and corresponding suitable weights of said floating body and of said dense solid body being chosen such that the average value of the net torque exerted by all the rocking levers on said line shaft being substantially uniform throughout, said rocking levers being arranged side by side and as close to each other as practically feasible (in order to accommodate an increased number of said rocking levers in per unit area of the surface of waves for increased power output) but maintaining a minimum distance in between for avoiding intermingling of said flexible links with each other, the said arrangement keeping said line shaft on revolving continuously in anticlockwise direction with fairly uniform speed, in order to restrict the fluctuation in the speed of rotation of said line shaft within permissible limits a single or a plurality of flywheels of appropriate moment of inertia being mounted on said line shaft, the rotation of said line shaft in only one direction (here in anticlockwise direction) producing an unbalanced moment trying to overturn said frame, in order to counterbalance this moment another line shaft, in parallel with the said line shaft along with said rocking lever and above said accessories with freewheeling mechanism operative in a direction to rotate this line shaft in clockwise direction (in a direction opposite to that of previously said line shaft), being provided, said line shaft being rotatable on said bearings housed in said bearing housings, said bearing housings being mounted on the opposite sides of said frame, said arms of said rocking levers attaching said floating body and said dense solid body being arranged here in a fashion (said floating body now being on the side of said line shaft in a position opposite to that of the previously said line shaft) such that the falling down floating body with the descending wave underneath now pulling the arm of said rocking lever to rotate this another line shaft in clockwise direction with the speed of rotation substantially equal to that of previously said line shaft, the rotations of these two parallel line shafts on one frame in opposite directions countering the unbalanced moment produced by each on said frame, in order to transfer power from the said line shafts rotating in opposite directions into the unidirectional rotation of one common shaft suitable power transmitting means (e.g. belts and pulleys or gears trains or both) being used to rotate one common shaft rotatable in bearings housed in bearing housings mounted on said frame or on the extension of said frame, preferably with the help of brackets, said common shaft, with the above said arrangements, rotating in one direction (here in anticlockwise direction) with the force of wave in vertical direction, a single or a plurality of output flywheels being mounted on said common shaft to restrict the fluctuations in the speed of rotation within permissible limits, an extension of said common shaft with suitable power transmitting means (e.g. belt and pulleys or gears trains or both) being used as prime mover for power generator(s) or for rotating other machine (s).

According to a preferred feature of the present invention the said floating body is made of a hollow, preferably cylindrical body with, preferably substantially hemispherical bottom and conical top, the diameter of the cylindrical portion being, preferably less than one fourth of the average wavelength of surface waves prevailing at that location (in order to float with the least possible contact on the surface of waves), the apex of said conical top being attached with said flexible link, the cylindrical portion being, preferably just long enough to the extent that its top conical portion remaining always above the splash of water from the surface waves, said floating body being made heavy enough to exert the maximum possible pulling force on said arm of said rocking lever while falling down with the descending wave underneath, which being achieved, preferably by adding small balls of heavy material inside the hollow floating body made of plastic or other corrosion resistant materials.

According to another preferred feature of the present invention the said dense solid body is a dense solid mass of thin cylindrical body with conical shape at both ends, one end of which being attached with said flexible link (on the side opposite to that of said floating body), the conical ends allowing it to move through water with minimum resistance.

It should be understood that the length of said flexible link, attaching the said floating body and arm of said rocking lever, is made, preferably just long enough to the extent to make said arm of said rocking lever substantially horizontal when the said floating body is in the mid of its travel from the up-most to the down-most position (i.e. the mid position in between the crest and trough of the wave underneath said floating body) and this is within the scope and the principle of this invention.

It should be understood further that said dense solid body along with the attached flexible link may be replaced, without affecting the scope or principle of this disclosure, by a single or a plurality of spring connecting said arm of said rocking lever on its one and said frame on the other end in order to keep said flexible link just free of any sag/backlash during the period of upwards push of said floating body from the force of ascending wave underneath. This may be done without restricting the principle and the scope of this invention.

It should be understood still further that the said dense solid body, by adjusting the length of said flexible link attached with it, may be made to remain out of or immersed into water throughout or during a part of its movement in vertical plane as or when demanded to avoid the problems due to wind or disturbance to sea habitats and is within the principle and the scope of this invention.

It should be understood further that even only one-line shaft may be used if the arrangements for supporting said frame is made strong enough to counter the overturning moment and this is within the scope and the principle of this invention.

Rocking lever assembly for harnessing energy from surface waves substantially as herein described and illustrated in the figures of the accompanying drawings and as described herein with reference thereto is only by the way of example. It should be understood that various other changes, omissions and additions may be made without departing from the spirit or without restricting the scope and the principle of this invention.

The materials, design or construction of said floating body, said dense solid body, said rocking lever, said flexible link, said line shaft, said common shaft, said bearing, said bearing housing, said frame, said pulley, said bracket, said flywheel, said power transmitting belt, said gears train and said supporting floats or structures may be adopted in many ways and are not critical in this invention.

1. Rocking lever assembly for harnessing energy from surface waves comprising at least a floating body, a dense solid body, a rocking lever with two arms in opposite directions and a freewheeling mechanism in between, a plurality of flexible links, at least a line shaft, a plurality of bearing housings with bearings, a frame, a common shaft, at least a flywheel, a plurality of power transmitting means (e.g. a plurality of belt and pulleys or/and gears trains), said floating body of suitable shape and weight being attached with one end of a flexible link of suitable length, the other end of which being attached with the end of one arm of said rocking lever, the end of the opposite arm of said rocking lever being attached with another flexible link, the other end of which being attached with said dense solid body of suitable weight and shape, said rocking lever, with two said arms on the opposite sides and a freewheeling mechanism in between, being mounted on said line shaft, said line shaft being rotatable in bearings, said bearings being mounted on said line shaft and housed in said bearing housings, said bearing housings being mounted on the opposite sides of, preferably a substantially rectangular frame, said frame along with said line shaft and said rocking lever being held above the surface of waves and stationed at a preferred location (the most suitable for the availability of waves with maximum amplitude) on being attached, preferably detachably with suitably shaped anchored floats or with suitable structural supports (designed to pose the least possible interference to the propagation of waves), said rocking lever along with said arms on the opposite sides and said freewheeling mechanism in between being rock able with angular motion in a substantially vertical plane on said line shaft about its axis as fulcrum, said floating body being pushed upward by the force of ascending wave from underneath causing a decrease of tension in said flexible link attaching said floating body, the decrease of tension in said flexible link (attaching said floating body) causing said dense solid body (attached with the end of opposite arm of said rocking lever) to fall down by pulling said arm of said rocking lever (to which it being attached) along by rotating freely with said freewheeling mechanism on said line shaft (as the free rotation being allowed here in clockwise direction on said line shaft) causing said arm of said rocking lever (on the side of said floating body) to move upward by stretching said flexible link (attached with said floating body) with a consequent regain of tension in said flexible link, the weight of said dense solid body (including that of said flexible link on this side) and the length of the arm of said rocking lever (on this side) being chosen to produce a moment just sufficient to maintain said flexible link (attaching said floating body) free of any sag or backlash up to the period till so long as the wave underneath said floating body keeping on rising to attain crest, after attaining crest the wave underneath said floating body starting to recede down causing said floating body to fall down by pulling said arm of said rocking lever down in anti-clockwise direction along with said freewheeling mechanism by rotating said line shaft along in anti-clockwise direction (as the free rotation of said freewheeling mechanism on said line shaft being not allowed in anticlockwise direction) with a net torque (the net amount of torque exerted on said line shaft by falling down floating body in anticlockwise direction after subtracting the value of torque exerted by said dense solid body acting on the arm of said rocking lever in clockwise direction), the above said situation prevailing up to the period till the wave underneath said floating body keeping on sinking down towards the depth (the trough), the wave underneath said floating body keeping on repeating the above said cycle along with said floating body and so on the cycle of rocking of said rocking lever too going on repeating, said net torque on said line shaft being available during half of the rocking cycle only (during the period till the wave underneath said floating body continuing to recede down), in order to maintain this torque available uniformly throughout the rocking cycles for keeping said line shaft on revolving continuously in anticlockwise direction a plurality of said rocking levers with said freewheeling mechanisms (with free rotation in clockwise direction) along with said accessories (e.g. said floating body, said dense solid body, said flexible links) attached with the corresponding arms of said rocking levers with varying arm lengths (in order to cover a number of waves simultaneously) and corresponding suitable weights of said floating body and of said dense solid body being chosen such that the average value of the net torque exerted by all the rocking levers on said line shaft being substantially uniform throughout, said rocking levers being arranged side by side and as close to each other as practically feasible (in order to accommodate an increased number of said rocking levers in per unit area of the surface of waves for increased power output) but maintaining a minimum distance in between for avoiding intermingling of said flexible links with each other, the said arrangement keeping said line shaft on revolving continuously in anti-clockwise direction with fairly uniform speed, in order to restrict the fluctuation in the speed of rotation of said line shaft within permissible limits a single or a plurality of flywheels of appropriate moment of inertia being mounted on said line shaft, the rotation of said line shaft in only one direction (here in anticlockwise direction) producing an unbalanced moment trying to overturn said frame, in order to counterbalance this moment another line shaft, in parallel with the said line shaft along with said rocking lever and above said accessories with freewheeling mechanism operative in a direction to rotate this line shaft in clockwise direction (in a direction opposite to that of previously said line shaft), being provided, said line shaft being rotatable on said bearings housed in said bearing housings, said bearing housings being mounted on the opposite sides of said frame, said arms of said rocking levers attaching said floating body and said dense solid body being arranged here in a fashion (said floating body now being on the side of said line shaft in a position opposite to that of the previously said line shaft) such that the falling down floating body with the descending wave underneath now pulling the arm of said rocking lever to rotate this another line shaft in clockwise direction with the speed of rotation substantially equal to that of previously said line shaft, the rotations of these two parallel line shafts on one frame in opposite directions countering the unbalanced moment produced by each on said frame, in order to transfer power from the said line shafts rotating in opposite directions into the unidirectional rotation of one common shaft suitable power transmitting means (e.g. belts and pulleys or gears trains or both) being used to rotate one common shaft rotatable in bearings housed in bearing housings mounted on said frame or on the extension of said frame, preferably with the help of brackets, said common shaft, with the above said arrangements, rotating in one direction (here in anticlockwise direction) with the force of wave in vertical direction, a single or a plurality of output flywheels being mounted on said common shaft to restrict the fluctuations in the speed of rotation within permissible limits, an extension of said common shaft with suitable power transmitting means (e.g. belt and pulleys or gears trains or both) being used as prime mover for power generator(s) or for rotating other machine(s).

2. Rocking lever assembly for harnessing energy from surface waves as claimed in claim 1, wherein the said floating body is made of a hollow, preferably cylindrical body with, preferably substantially hemispherical bottom and conical top, the diameter of the cylindrical portion being, preferably less than one fourth of the average wavelength of surface waves prevailing at that location (in order to float with the least possible contact on the surface of waves), the apex of said conical top being attached with said flexible link, the cylindrical portion being, preferably just long enough to the extent that its top conical portion remaining always above the splash of water from the surface waves, said floating body being made heavy enough to exert the maximum possible pulling force on said arm of said rocking lever while falling down with the descending wave underneath, which being achieved, preferably by adding small balls of heavy material inside the hollow floating body made of plastic or other corrosion resistant materials.

3. Rocking lever assembly for harnessing energy from surface waves as claimed in claim 1, wherein the said dense solid body is a dense solid mass of thin cylindrical body with conical shape at both ends, one end of which being attached with said flexible link (on the side opposite to that of said floating body), the conical ends allowing it to move through water with minimum resistance.

4. Rocking lever assembly for harnessing energy from surface waves substantially as herein described and illustrated in the figures of the accompanying drawing.
